(19) United States
(12) Patent Application Publication
(10) Pub. No.: US 2026/0014825 A1
(43) Pub. Date: Jan. 15, 2026

(54) TOWING DEVICE

(71) Applicant: MAGNA STEYR Fahrzeugtechnik GmbH & Co KG, Graz (AT)

(72) Inventors: Michael SCHLENER, Graz-Ragnitz (AT); Vojkan ZORIC, Graz (AT); Dietmar GOETTFRIED, Hausmannstaetten (AT); David LECHNER, Graz (AT)

(21) Appl. No.: 19/260,363

(22) Filed: Jul. 4, 2025

(30) Foreign Application Priority Data
Jul. 15, 2024 (EP) EP24188585.4

(51) Int. Cl. B60D 1/48

(52) U.S. Cl. CPC B60D 1/488

(57) ABSTRACT

A towing device for retrofitting a trailer hitch to a motor vehicle, a motor vehicle having such a towing device, and a method for producing a motor vehicle. The towing device includes an elongated bracket for fastening to a crossmember of the motor vehicle frame for extension, at least in part, along the crossmember; a trailer hitch for attachment to the bracket; a screw plate received in the crossmember in a mounted state thereof to engage an inner surface of at least one portion of the crossmember; and a plurality of first fastening members to fasten the bracket to the screw plate and thereby clamp the crossmember between the bracket and the screw plate.

### CROSS-REFERENCE TO RELATED APPLICATIONS

The present disclosure claims priority under 35 U.S.C. § 119 to European Patent Publication No. EP 24188585.4 (filed on Jul. 15, 2024), which is hereby incorporated by reference in its complete entirety.

### TECHNICAL FIELD

The present disclosure relates to a towing device for retrofitting a trailer hitch to a motor vehicle, a motor vehicle having such a towing device, and a method for producing a motor vehicle.

### BACKGROUND

It is known that motor vehicles may be equipped with a trailer hitch, for example in order to couple a trailer to the trailer hitch and take it along with the motor vehicle. Some motor vehicles are not equipped with such a trailer hitch ex works. Retrofitting a trailer hitch in a motor vehicle can be difficult and time-consuming, depending on the existing load-bearing structure and its geometry. Should it be possible, the trailer hitch should be such that it can be mounted without extensive disassembly work on the vehicle. Welding work on the existing vehicle should be avoided as far as possible. Moreover, fastening a trailer hitch to the vehicle must also ensure ideal load distribution.

German Patent Publication No. DE 10 2021 120 475 A1 discloses a kit for mounting a rear carrier to a bumper of a motor vehicle, comprising an adapter that can be connected to a crossmember of the bumper and a ball-head coupling designed for fastening the rear carrier, wherein the adapter has a first retaining disc, and has a second retaining disc, which can be positioned at a distance from the first retaining disc, for fastening the ball-head coupling between the first retaining disc and the second retaining disc, wherein the first retaining disc and the second retaining disc each have a substantially U-shaped receiving opening for engaging around a rear side that faces rearwards in the x-direction, an upper side that projects from the rear side in the x-direction, and a lower side of the crossmember that projects from the rear side in the x-direction, wherein the adapter has a mounting flange, which can be fastened to the first retaining disc and/or to the second retaining disc via detachable fastening members that extend past the rear side, the upper side and the lower side.

### SUMMARY

It is an object of the present disclosure to present a towing device for retrofitting a trailer hitch to a motor vehicle, which avoids at least some of the aforementioned problems and, in particular, is easy to retrofit and enables good load distribution on the motor vehicle. Also to be disclosed are a motor vehicle having such an improved towing device, and a simple and cost-effective method for producing such a motor vehicle, in particular by retrofitting the towing device.

The object is achieved by a towing device for retrofitting a trailer hitch to a motor vehicle, the motor vehicle having a load-bearing vehicle frame, the vehicle frame having a crossmember that has a profile, the towing device comprising a bracket and a trailer hitch, the bracket being an elongate component, such that the bracket can extend, at least in part, along the crossmember when it is fastened to the crossmember, the trailer hitch being such that it can be fastened to the bracket, the towing device comprising a screw plate, the screw plate being an elongate component that is designed to be inserted laterally into the profile of the crossmember and/or to bear against the profile, inside the profile of the crossmember (6), such that the screw plate in the mounted state is arranged within the profile of the crossmember and bears against the inner side of the profile on at least one circumferential portion of the profile, the bracket and the screw plate being realized in such a way that the bracket is fastened to the screw plate via first fastening members, in particular via screws, in such a way that the profile of the crossmember is clamped between the bracket and the screw plate.

According to the present disclosure, a towing device comprises a bracket to which the trailer hitch can be fastened, is fastened or which realizes the trailer hitch, and additionally a screw plate. Both the bracket and the screw plate are elongate components that, in the mounted state, extend along a crossmember of the vehicle. In the mounted state, the screw plate is inserted into the crossmember and is thus located inside the crossmember. In the mounted state, the bracket and screw plate are fastened to each other along their extent on the crossmember by fastening members, in particular via screws, such that the profile of the crossmember is clamped between the bracket and screw plate.

The bracket and the geometric design of the screw plate for mounting a trailer hitch are thus realized in such a way that they may be installed without extensive disassembly work as soon as the profile of a crossmember is open from the side. This design means that no welding work is required on the existing vehicle. Due to its elongate extent, the screw plate is designed to ensure an ideal load distribution.

The term “elongate” for a component means that the component is realized so as to be as longer in one direction than in the two directions that are normal thereto, preferably at least twice as long. In this longer direction, the component therefore has “axial ends” at both ends. In the assembled state, this longer direction of the components is oriented along the longitudinal extent of the crossmember. The crossmember is oriented substantially normal to the direction of travel of the motor vehicle. The crossmember is part of a load-bearing vehicle frame, the load-bearing vehicle frame being, in particular, a ladder-type frame. The term “substantially normal to” also includes vehicles that have a crossmember that is not straight, the crossmember being, for example, bent in its longitudinal extent—transverse to the direction of travel—or being provided with slight angle corrections in order to fit better into the vehicle structure.

The fastening of a trailer hitch may be conducted via a bracket and an inserted screw plate and/or a screw plate bearing against the inner side of the profile on an existing cross connection on a ladder-type frame without welding work, preferably with included reinforcement measures for the take-up of forces.

Some advantages that can be achieved with the present disclosure are as follows.
Avoidance of welding work on a motor vehicle in the retrofitting of a trailer hitch.
Preferably, holes required for screw connection are already provided in the crossmember during the development of the vehicle. Preferably, therefore, the crossmember of the motor vehicle already has the holes for passing through the fastening members.
Vehicles that do not have a trailer hitch may easily be equipped with one, for example by the customer of the motor vehicle.
An insert part serves to reinforce and evenly transfer force to the surrounding components. Owing to this reinforcement of the vehicle structure, it is possible, merely via the towing device according to the present disclosure, to retroactively impart to the vehicle the rigidity and strength of the vehicle structure that is required for the hitching/towing of trailers, as a result of which the standard basic vehicle equipment becomes cheaper and, most importantly, the weight of the vehicle can be reduced.
Should it not be possible to “enclose” the transverse tube due to limited installation space, this solution may still be used to fasten a towing device to a motor vehicle.

Preferably, the profile of the crossmember is a closed profile, in particular a round profile or a square profile, or the profile of the crossmember is an open profile that defines an interior, such as, in particular, a C-profile. The transverse tube may, for example, have both regions with a closed profile and regions with an open profile along its extent in the longitudinal direction.

The circumferential portion of the profile, against which the screw plate bears when in the assembled state, is preferably bent, in particular in the shape of an arc, and the screw plate is therefore preferably bent in this circumferential portion, in particular in the shape of an arc, such that the screw plate can bear against the circumferential portion of the profile.

Preferably, the bracket is fastened to the screw plate via a plurality of first fastening members, in particular a plurality of screws arranged in series, along its extent in the longitudinal direction, in such a way that the profile of the crossmember is clamped between the bracket and the screw plate.

Preferably, the bracket and the screw plate have a plurality of mutually assigned screw holes along their extent in the longitudinal direction, such that the bracket can be fastened to the screw plate via screws extending through the screw holes.

Preferably, the bracket has a fastening flange at at least one axial end, preferably at both axial ends, for fastening the bracket to the vehicle frame, in particular to a longitudinal member of the vehicle frame.

Preferably, the screw plate has a fastening flange at at least one axial end, preferably at both axial ends, for fastening the screw plate to the vehicle frame, in particular to the crossmember of the vehicle frame, the bracket not being fastened to the fastening flange.

The screw plate is preferably of such a length that it extends at least from an inner edge of a longitudinal member to the inner edge of an opposite longitudinal member of the vehicle frame. Particularly preferably, the screw plate even extends at least from an outer edge of a longitudinal member to the outer edge of an opposite longitudinal member of the vehicle frame, and preferably projects beyond the longitudinal member.

The screw plate is preferably of a single-part design, but may also be composed of a plurality of parts.

A motor vehicle according to the present disclosure has a load-bearing vehicle frame, in particular a ladder-type frame, the vehicle frame having a crossmember that has a profile, the towing device comprising a bracket and a trailer hitch, the bracket being an elongate component, such that the bracket extends, at least in part, along the crossmember and is fastened to the crossmember, the trailer hitch being fastened to the bracket, the towing device comprising a screw plate, the screw plate being an elongate component that is inserted laterally into the profile of the crossmember, such that the screw plate is arranged within the profile of the crossmember and bears against the inner side of the profile on at least one circumferential portion of the profile, the bracket being fastened to the screw plate via first fastening members, in particular via screws, in such a way that the profile of the crossmember is clamped between the bracket and the screw plate.

The crossmember of the motor vehicle preferably has, along its extent in the longitudinal direction, a plurality of screw holes that are assigned to the screw holes of the bracket and the screw plate, such that the first fastening members, in particular screws, for fastening the bracket to the screw plate and for clamping the profile of the crossmember extend through the screw holes of the crossmember.

The towing device of the motor vehicle preferably also has other features mentioned above for a towing device according to the present disclosure.

A method for producing such a motor vehicle having a towing device comprises inserting the screw plate laterally into the profile of the crossmember and/or engaging the screw plate against the crossmember, inside the profile of the crossmember, such that the screw plate is arranged within the profile of the crossmember and bears against the inner side of the profile, at least on a circumferential portion of the profile, the bracket being fastened to the screw plate via first fastening members, in particular via screws, in such a way that the profile of the crossmember is clamped between the bracket and the screw plate.

Developments of the present disclosure are presented in the dependent claims, the description and the appended drawings.

### DRAWINGS

The present disclosure will be described by way of example below with reference to the drawings.

FIG. 1 is an exploded representation of a towing device without a trailer hitch, in accordance with the present disclosure.

FIG. 2 is a three-dimensional representation of a towing device (without a trailer hitch) mounted on a motor vehicle, in accordance with the present disclosure.

FIG. 3 is a three-dimensional representation of a motor vehicle in the region of the towing device (without a trailer hitch), in accordance with the present disclosure.

FIG. 4 is a three-dimensional representation of the position of a screw plate of the towing device in a motor vehicle, in accordance with the present disclosure.

FIG. 5 is a sectional view of a screwed connection of the bracket to the screw plate in a motor vehicle, in accordance with the present disclosure.

### DESCRIPTION

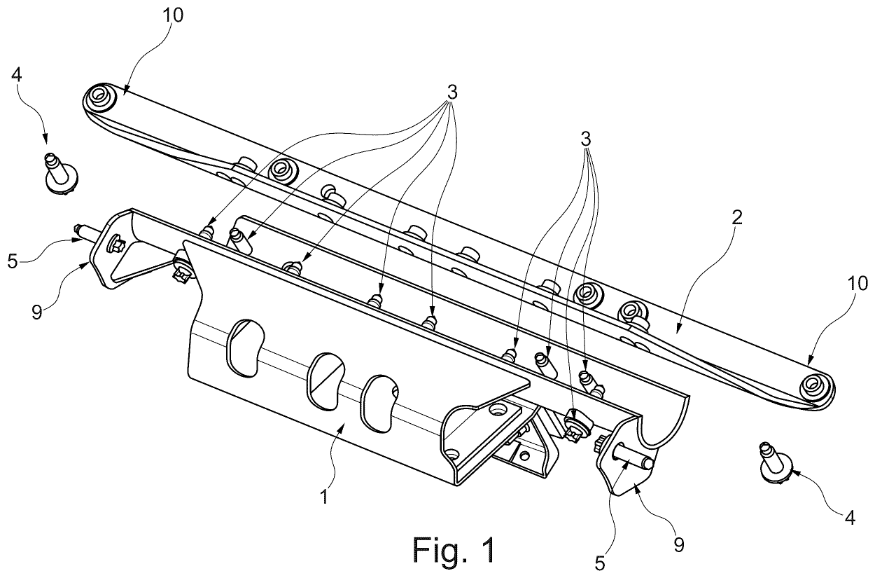

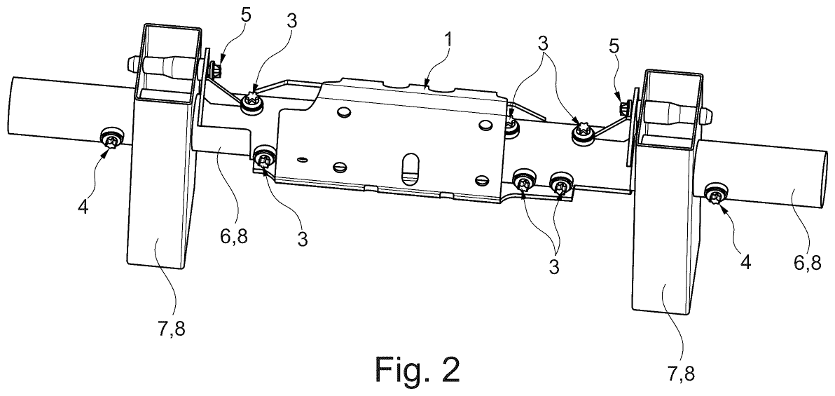

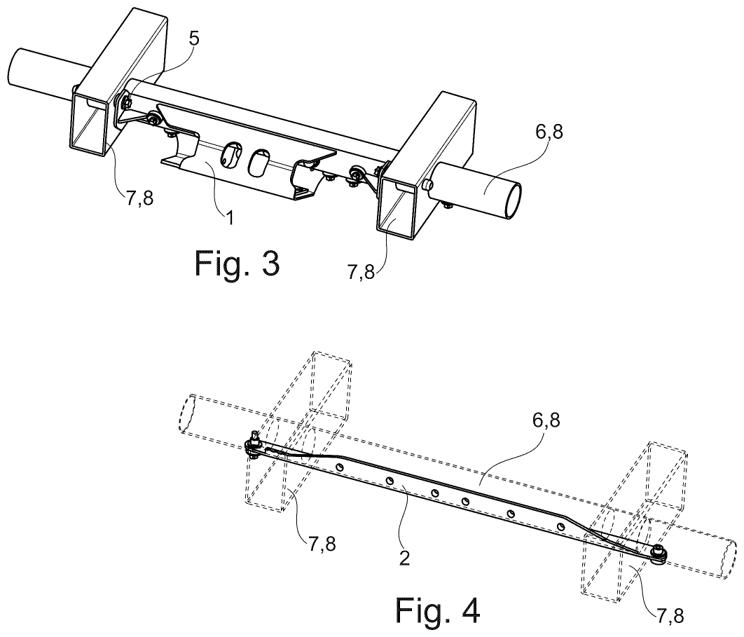

Represented in FIG. 1 is a towing device without a trailer hitch, in accordance with the present disclosure. FIGS. 2 and 3 show the towing device (without a trailer hitch) fitted on a motor vehicle. FIG. 4 shows the position of the screw plate 2 on the vehicle frame 8, namely in the crossmember 6.

A screw plate 2 is pushed or inserted into an existing transverse connection, namely into a laterally open crossmember 6, and thus, constitutes the basis for the screw connections of the bracket 1, which is itself the basis for the trailer hitch, to the motor vehicle. The geometric shape of the transverse tube that forms the crossmember 6 may vary. Different transverse tube geometries, for example round, rectangular or C-profile, may be used to fasten the towing device, by simple geometric adaptations to the contour of bracket 1 and screw plate 2.

Owing to the design of the screw plate 2, a reinforcing function of the overall system is achieved. The forces resulting from operation are distributed evenly and over a large area by the screw plate 2 to the transverse connection, namely the crossmember 6, and also to the longitudinal structure of the vehicle, namely the longitudinal member 7. Use of the inserted screw plate 2 makes it possible to avoid the use of through-holes in the transverse tube, as well as inserted, or welded, sleeves in the transverse tube, in order to produce a firm screw joint.

The screw plate 2 is designed so that it extends as far outwards as possible in order to also transfer forces into the longitudinal structure of the vehicle, i.e. the longitudinal member 7. The screw plate 2 has a distinctly elongate shape and is flat. However, the face of the screw plate 2 may have bends and/or edges, for example in part.

The screw plate 2 is of such a length that it extends at least from one outer edge of a longitudinal member 7 to the outer edge of the opposite longitudinal member 7 of the vehicle frame 8 and projects beyond it.

The first fastening members 3, namely screws, clamp the bracket 1 in combination with the screw plate 2 to the transverse tube, or the crossmember 6. The third fastening members 5, namely screws, create an additional connection to the vehicle, preferably to longitudinal members 7 of the vehicle.

Second fastening members 4, namely screws, additionally clamp the screw plate 2 in the outer region, i.e., at its axial ends, to the transverse tube, or the crossmember 6, and enable an additional transfer of force into the longitudinal structure of the vehicle. The screw plate 2 has a respective fastening flange 10 at both axial ends, which forms the end regions of the screw plate and is designed for fastening the screw plate 2 to the vehicle frame 8, namely to the crossmember 6 of the vehicle frame 8. The bracket 1 is preferably not fastened to the screw plate 2 in these end regions, and thus not to the fastening flanges 10.

The screw plate 2 is designed in such a way that it can be fitted on the vehicle without time-consuming disassembly work. The bracket 1 for the trailer hitch is designed in such a way that it can be fastened to the vehicle via screws only.

The bracket 1 has a respective fastening flange 9 at both axial ends, for fastening the bracket 1 to the longitudinal members 7 of the vehicle frame 8. The two fastening flanges 9 are normal to the longitudinal extent of the bracket 1, such that they are oriented parallel to the longitudinal members 7. The bracket 1 is of an elongate design, at least in regions in which it is screw-connected to the screw plate. The bracket 1 has a region for fastening the trailer hitch, which does not have to be of an elongate design.

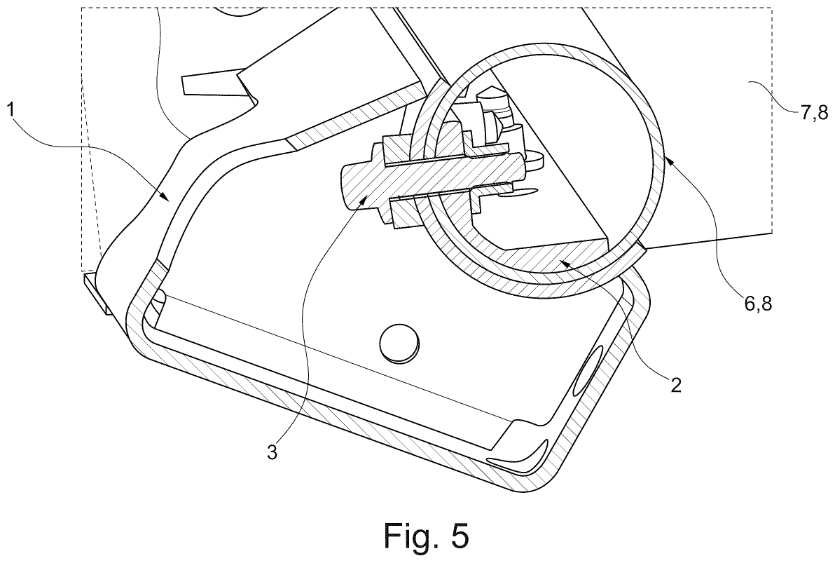

FIG. 5 shows a sectional view of a screwed connection of the bracket 1 to the screw plate 2 in a motor vehicle according to the present disclosure via a first fastening members 3.

The crossmember 6 has a circular profile. The circumferential portion of the profile on the crossmember 6, against which the screw plate 2 rests, is therefore bent, namely in the shape of an arc, and the screw plate 2 is therefore likewise bent in this circumferential portion, namely substantially in the shape of an arc.

The terms “coupled,” “attached,” or “connected” may be used herein to refer to any type of relationship, direct or indirect, between the components in question, and may apply to electrical, mechanical, fluid, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 bracket
2 screw plate
3 first fastening members, screw
4 second fastening members, screw
5 third fastening members, screw
6 crossmember
7 longitudinal member
8 vehicle frame, ladder-type frame
9 fastening flange
10 fastening flange

What is claimed is:

1. A towing device to retrofit a trailer hitch to a motor vehicle having a load-bearing vehicle frame having a crossmember, the towing device comprising:
an elongated bracket for fastening to the crossmember for extension, at least in part, along the crossmember;
a trailer hitch for attachment to the bracket;
a screw plate received in the crossmember in a mounted state thereof to engage an inner surface of at least one portion of the crossmember; and
a plurality of first fastening members to fasten the bracket to the screw plate and thereby clamp the crossmember between the bracket and the screw plate.

2. The towing device of claim 1, wherein the crossmember is formed having a closed profile.

3. The towing device of claim 2, wherein the closed profile comprises a circular profile or a square profile.

4. The towing device of claim 2, wherein the closed profile comprises a square profile.

5. The towing device of claim 1, wherein the crossmember is formed having an open profile that defines an interior surface.

6. The towing device of claim 4, wherein the open profile comprises a C-profile.

7. The towing device of claim 1, wherein the portion of the crossmember that is engaged by the screw plate has an arc-shape.

8. The towing device of claim 1, wherein the plurality of first fastening members comprise screws arranged in series.

9. The towing device of claim 7, wherein the bracket comprises a plurality of screw holes arranged in a longitudinal direction thereof to receive a corresponding one of the screws.

10. The towing device of claim 7, wherein the screw plate comprises a plurality of screw holes arranged in a longitudinal direction thereof to receive a corresponding one of the screws.

11. The towing device of claim 1, wherein at least one axial end of the bracket has a fastening flange which fastens the bracket to a longitudinal member of the vehicle frame.

12. The towing device of claim 1, wherein at least one axial end of the screw plate has a fastening flange which fastens the screw plate to the crossmember.

13. The towing device of claim 1, wherein the screw plate extends at least from an inner edge of a first longitudinal member of the vehicle frame to an inner edge of an opposite, second longitudinal member of the vehicle frame.

14. The towing device of claim 1, wherein the screw plate extends at least from an outer edge of a first longitudinal member of the vehicle frame to an outer edge of an opposite, second longitudinal member of the vehicle frame.

15. The towing device of claim 1, wherein the bracket is formed as an elongate component.

16. The towing device of claim 1, wherein the screw plate is formed as an elongate component.

17. The towing device of claim 1, further comprising a plurality of second fastening members operable to clamp the screw plate at its axial ends thereof to the crossmember.

18. The towing device of claim 1, wherein the plurality of second fastening members comprise screws.

19. A towing device, comprising:
an elongated bracket for fastening to a crossmember of a motor vehicle frame for extension, at least in part, along the crossmember;
a trailer hitch for attachment to the bracket;
a screw plate received in the crossmember in a mounted state thereof to engage an inner surface of at least one portion of the crossmember; and
a plurality of fastening members to clamp the crossmember between the bracket and the screw plate.

20. A motor vehicle, comprising:
a load-bearing vehicle frame having a crossmember; and
a towing device that includes:
an elongated bracket for fastening to the crossmember for extension, at least in part, along the crossmember,
a trailer hitch for attachment to the bracket,
a screw plate received into the crossmember in a mounted state thereof to engage an inner surface of at least one portion of the crossmember, and
a plurality of first fastening members to fasten the bracket to the screw plate and thereby clamp the crossmember between the bracket and the screw plate.
